(19) United States
(12) Patent Application Publication
(10) Pub. No.: US 2003/0153351 A1
(43) Pub. Date: Aug. 14, 2003

(54) System for use in a monitoring and management system based on the internet

(75) Inventor: Woni Jung, Seoul (KR)

Correspondence Address: McGuireWoods LLP, Suite 1800, 1750 Tysons Boulevard, McLean, VA, 22102, US

(73) Assignee: K2WEB USA, LLC

(21) Appl. No.: 10/350,044

(22) Filed: Jan. 24, 2003

(30) Foreign Application Priority Data
Jan. 24, 2002 (KR) 2002-4137

(51) Int. Cl. H04B 1/38; H04M 1/00; G06F 15/16

(52) U.S. Cl. 455/550; 709/200

(57) ABSTRACT

A system for monitoring and management system based on the Internet enables a user access the Internet with a personal computer (PC) or a video phone from a remote place in order to monitor a current situation at a specific location (e.g., office, preschool, etc.) by receiving moving picture and audio data. The system of the present invention comprises a radio data receiver adapted to receive video and audio data acquired by each of a plurality of wireless web cameras and outputs the received video and audio data to a data modulator adapted to receive the outputted video and audio data to modulate them into an analog signal. The present invention further comprises a camera control section adapted to adjust channel, pan/tilt, zoom, focus and position of each of the plurality of wireless web cameras, a data acquisition section adapted to receive the video signal and audio signal corresponding to the modulated analog signal from the data modulator, which stabilizes the received video and audio signals, a program operating section adapted to store the video and audio data from the data acquisition section, and a Internet accessing section adapted to provide a user with the video and audio data stored in the program operating section.

### BACKGROUND OF THE INVENTION

1. Field of the Invention

The present invention generally relates to a repeater installation for use in a monitoring and management system based on the Internet, and more particularly, to a repeater installation for use in a monitoring and management system based on the Internet in which a user can access the Internet with a personal computer (PC) or a video phone at a remote place so as to permit transmission and reception of a moving picture and audio data corresponding to the current situation occurring at a specific location, i.e. his or her home, a preschool, a private educational institution, an office, or the like.

2. Description of the Related Art

Conventional technology has been well known which allows a user to monitor and manage a specific place as described above. This technology may typically include installing a monitoring camera at a specific monitored location so as to identify and view information photographed by a camera through a suitable output device (e.g. a monitor) at a remote place.

However, the conventional technology has a problem that the camera is installed at the specific monitored location in a fixed-wired manner. This greatly limits installation space and makes the camera installation difficult. As a result, installation cost is very high and requires specialized maintenance and repair accordingly.

Further, one PC could not support various monitoring cameras (hereinafter, referred to as “cameras”). Despite the advent of a combined wired and wireless systems, a user must build a multimedia service system personally using expensive equipment in order for him or her to obtain a monitoring service.

There is therefore a need for a monitoring and management system based on the Internet, which enables the building and provisioning of a home page associated with the monitoring and management system using a wireless web camera and the Internet. This system will then at any time allow a remote user tocheck, monitor and manage the current situation of a specific location wherever the wireless web camera is installed.

However, to create a monitoring and management system based on the Internet using conventional equipment, and to provide for an easy repeater installation of a system for transmitting and receiving a moving picture with audio, the system would require a radio receiver for receiving data wirelessly and a separate Internet accessing device for accessing the Internet for providing various signals generated from the radio receiver to an Internet user.

As a result, the size of the entire system becomes large, which requires an associated large installation space. Further, there is another basic problem in that only a unidirectional communication capability would be possible, instead of a more desireable bi-directional communication capability to enable an Internet user to remotely control the cameras.

### SUMMARY OF THE INVENTION

It is, therefore, an object of the present invention to solve the above problems and to provide a repeater installation of a monitoring and management system based on the Internet by combining a radio data receiver for receiving wireless data and an Internet accessing device for accessing the Internet. This achieves miniaturization of the entire system and convenience of use, and also allows a user to transmit a signal in a reverse direction for selecting from among the data transmitted by a plurality of wireless web cameras installed at various locations. Selecting any one of the plurality of video and audio signals, provides for monitoring and managing the current situation of a specific location wherever each of the wireless web cameras is installed.

To achieve the above objective of the present invention, there is provided a repeater installation for use in an Internet based monitoring and management system, comprising:

a radio data receiver adapted to receive video and audio data acquired by each of the plurality of wireless web cameras and adapted to output the received video and audio data;

a data modulator adapted to receive the outputted video and audio data from the radio data receiverfor modulating them into an analog signal and adapted to output the modulated analog signal;

a camera control section adapted to adjust channel, pan/tilt, zoom, focus and position of each of the plurality of wireless web cameras;

a data acquisition section adapted to receive the video signal and audio signal corresponding to the modulated analog signal from the data modulator and for stabilizing the received video and audio signals and adapted to output them;

a program operating section adapted to store the video and audio data applied thereto from the data acquisition section and adapted to adjust the size of the data, channel, pan/tilt, zoom, focus and position of each of the plurality of wireless web cameras;

an Internet accessing section adapted to provide a user with the video and audio data stored in the program operating section; and

a power supply adjusting section adapted to turn the power supply on and off.

### BRIEF DESCRIPTION OF THE DRAWINGS

Further objects and advantages of the invention can be more fully understood from the following detailed description taken in conjunction with the accompanying drawings.

FIG. 1 is a block diagram illustrating the construction of a monitoring and management system based on the Internet according to a preferred embodiment of the present invention, showing a repeater installation.

FIG. 2 is a block diagram illustrating the construction of a repeater installation for use in a monitoring and management system based on the Internet according to another embodiment of the present invention.

FIG. 3 is a flowchart illustrating the operation of respective constitutional elements of a repeater installation for use in a monitoring and management system based on the Internet according to the present invention.

### DETAILED DESCRIPTION OF THE PREFERRED EMBODIMENT

A preferred embodiment according to the present invention will now be described in connection with preferred embodiments with reference to the accompanying drawings.

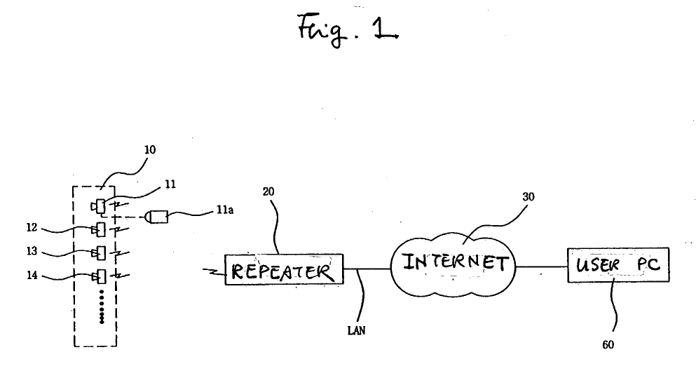

Referring to FIG. 1, a photographing section 10 comprising a plurality of wireless web cameras 11, 12, etc., which may be installed at any location where it is required to photograph a monitored object.

After each of the wireless web cameras 11, 12, etc., has photographed a moving picture at the monitored location, it sends out a wireless video signal containing information regarding the photographed moving picture.

A repeater 20, receives the moving picture information from a photographing section 10 and transmits a video signal and an audio signal associated with the received moving picture information to a service provider server 40 through the Internet 30.

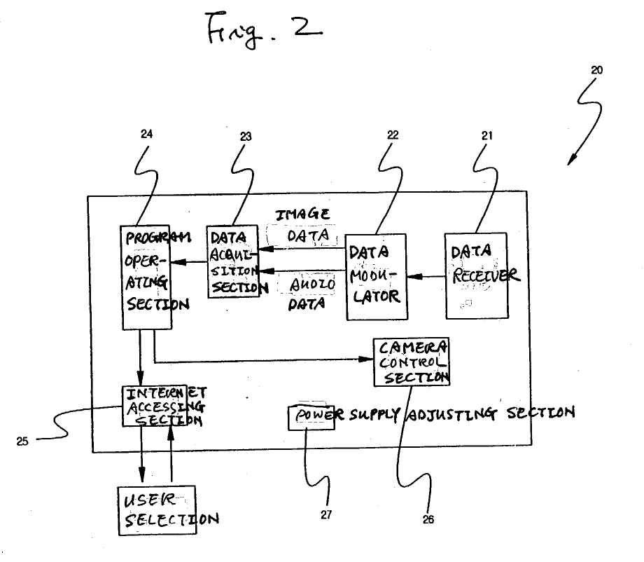

In the above illustrative construction of the system, the repeater 20 of the present invention, as shown in FIG. 2, includes a radio data receiver 21, a data modulator 22a data acquisition section 23, a program operating section 24, a Internet accessing section 25, a camera control section 26 and a power supply adjusting section 27.

The radio data receiver 21 acts to receive video and audio data acquired by each of a plurality of wireless web cameras 11, 12, etc. of the photographing section 10 and outputs the received video and audio data. The data modulator 22, serves to receive the outputted video and audio data from the radio data receiver 21 and modulates them into an analog signal and then outputs the modulated analog signal. The camera control section 26 adjusts channel, pan/tilt, zoom, focus and position of each of the plurality of wireless web cameras 11, 12, etc. The data acquisition section 23 receives the video signal and audio signal via the modulated analog signal from the data modulator 22 and outputs the received video and audio signals. The program operating section 24 stores the video and audio data supplied from the data acquisition section 23, and adjusts the size of the data, channel, pan/tilt, zoom, focuses and positions each of the plurality of wireless web cameras 11, 12, etc. The Internet accessing section 25 provides a user with the video and audio data stored in the program operating section 24. The power supply adjusting section 27 serves to turn the power supply on and off.

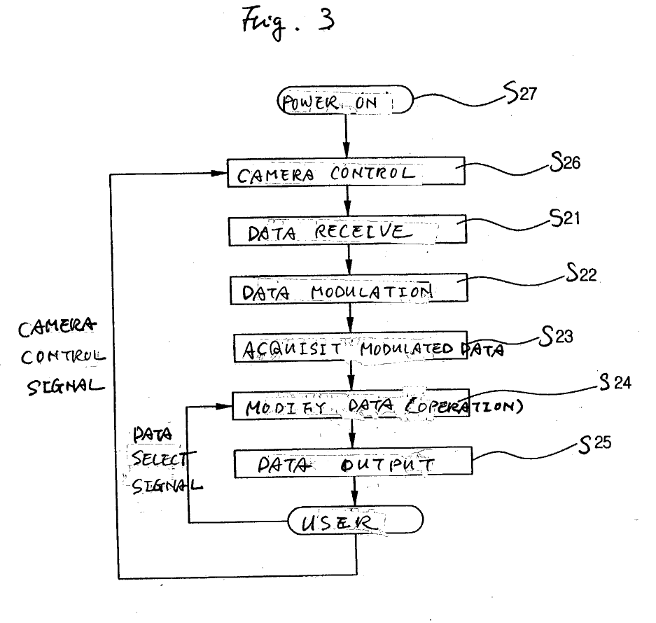

The operation and effect of the present invention having the above construction will be described in detail hereinafter with reference to FIGS. 2 and 3.

As shown in, FIGS. 2 and 3, when the power supply adjusting section 27 turns the power on at step S27, the wireless web cameras may be adjusted by the camera control section 26 as shown at step S26. The radio data receiver 21 receives the video and audio data acquired by each of the plurality of wireless web cameras 11, 12, etc. as shown at step S21. At this stage, the video and audio data is received in the form of a digital signal.

The digital video and audio data, outputted from the radio data receiver 21, is then supplied to the data modulator 22 which in turn modulates the digital video and audio data into analog signals as shown at step S22. The analog video and audio signals, modulated by the data modulator 22, are next supplied to the data acquisition section 23 for acquiring the modulated data, as shown at step S23, which in turn stabilizes the analog video and audio signals for submission to the program operating section 24.

Also, when motion is detected, a system will send a signal and update a database through the Internet. Therefore, even though the images are not constantly monitored, the motions are recorded in the database. This enables the user later review what had happened at certain point of time, when there is any activities.

Such feature could be implemented through software or through hardware. It may be also applied for security areas. If necessary, the system can contact a designated telephone number, the security company, or police department to report any unauthorized entry or other breach of security. Such security features are not limited to a motion detector and other device could also be attached, including but not limited to, glass breakage detector, and so on.

The recipient of the telephone call, the security company or the police department could log into the system via Internet and could access the recorded images and can also monitor the scene. This feature is the security monitoring aspects of the embodiment according to the present invention.

The program operating section 24 preferably consists of read-only-memory (ROM). The aim of using ROM is to minimize the volume of the repeater 20 and improve its functional efficiency. However, any other memory device or microprocessor would work.

Each of the analog video and audio signals outputted from the data acquisition section 23 is separately supplied to the program operating section 24 at step S24, where the program operating section 24 mixes data signals applied by a predetermined input program into one image to take the form of a small cell.

More specifically, the analog video and audio signals outputted from the data acquisition section 23, at step S23, are applied to the program operating section 24, at step S24, which, in turn, modulates analog video and audio signals into the digital signals for transmission to the user PC 60 across the Internet 30 through the Internet accessing section 25, as shown at step S25.

At this time, an initial screen of a home page transmitted to the user is divided into sections corresponding to the number of the wireless web cameras 11, 12, etc. constituting the photographing section 10 to form a number of frames. When the initial screen of the home page is configured in such a manner, audio data is not provided to the user. When this initial screen is provided to the user, he or she may focus his or her eyes on any one of numerous frames constituting the initial screen to monitor and manage a frame. Then, when a signal, inititated by the user, for selecting any one of the wireless web cameras 11, 12, etc. is transmitted to the program operating section 24 through the Internet, the program operating section 24, being connected to the Internet accessing section 25, receives the signal of the selected wireless web camera and. As a result, it supplies the received video and audio signal to the user PC 60, via the Internet 30. It is done through the Internet accessing section 25. At this time, the video and audio data of the selected wireless web camera are provided to the user PC 60 for reviewing and managing the current situation associated with the selected camera.

In the meantime, when a signal for adjusting a photographing region of the selected wireless web camera is transmitted to the repeater 20, the Internet accessing section 25 of the repeater 20 receives the signal for adjusting the photographing region by supplying it to the program operating section 24 in a direction opposite to a transmission direction of the video and audio data. Then, the program operating section 24 determines the type of the received photographing region adjusting signal and processes data by a predetermined program, according to the determined signal, in order to supply only the selected frame to the user.

At this time, the video and audio signals of the other wireless web cameras except the selected wireless web camera are transmitted to the program operating section 24 in real time.

Meanwhile, when the camera control section 26 transmits an adjusting signal from a user to the selected wireless web camera through the program operating section 24, the selected wireless web camera is operated by the adjusting signal so that the video and audio data of the selected wireless web camera is provided to a screen on a home page of the user through the Internet in real time.

In an alternative embodiment of the present invention, when the program operating section 24 receives a signal for selecting the wireless web cameras 11, 12 . . . according to the user input, it determines the type of the received signal to supply it to the camera control section 26 in a direction opposite to a transmission direction of the video and audio data.

When receiving the signal, the program operating section 24 stops a transmission function of the radio data receiver 21 for only the selected wireless web camera so that only the data of the selected wireless web camera can be transmitted to the user PC 60. Of course, when the user selects other wireless web cameras or the initial screen mode to select a signal for the actuation of all the wireless web cameras, the selected signal is transmitted to the wireless web camera to release the stopped transmission function of the radio data receiver 21 so as to provide the initial screen condition to the user.

As described above, according to the present invention, a user can access the Internet with a personal computer (PC) or a video phone at a remote place in order to receive a transmission of a moving picture and audio data corresponding to the present situation occurring at a specific location, e.g., his or her home, a preschool, a private educational institution, an office, etc. In addition, the present invention enables the combination of a radio data receiver for receiving wireless data and an Internet accessing device for accessing the Internet to provide various signals generated from the radio data receiver to a user to perform two functions, thereby attaining miniaturization of the entire system and convenience in use, and enables a user to transmit a signal in a reverse direction for selecting the data transmitted by a plurality of wireless web cameras installed at various locations. It also enables a user to select any one of the plurality of video and audio signals to be transmitted so as to monitor and manage the current situation of a specific location where each of the wireless web cameras is installed.

While this invention has been described in connection with what is presently considered to be the most practical and preferred embodiment, it is to be understood that the invention is not limited to the disclosed embodiment, but is intended to cover various modifications, variations or equivalents within the spirit and scope of the appended claims.

What is claimed is:

1. A system for a monitoring and managing system based on the Internet, comprising:
a plurality of wireless web cameras adapted to transmit audio and video data; and
a repeater in wireless communication with the plurality of wireless web cameras and in communication with the Internet,
wherein the repeater is capable of controlling the operation of the plurality of wireless web cameras under direction of a signal sent from across the Internet, and
wherein the repeater is capable of selectivity transmitting audio and video signals of each of the plurality of wireless web cameras over the Internet.

2. The system of claim 1, wherein the repeater further comprises:
a radio data receiver adapted to receive video and audio data signals acquired by each of the wireless web cameras and adapted to output the received video and audio data;
a data modulator adapted to receive the outputted video and audio data signals and adapted to modulate them into an analog signal and adapted to output the modulated analog signal;
a data acquisition section adapted to receive the modulated analog signal and adapted to stabilize the video and audio data signals therein, and adapted to output the video and audio data;
a program operating section adapted to receive and store the video and audio data from the data acquisition section and adapted to control the operation of each of the plurality of wireless web cameras; and
an Internet accessing section adapted to transmit the video and audio data stored by the program operating section over the Internet.

3. The system of claim 2, wherein when a user selects any of the plurality of wireless web cameras, a selection signal is sent across the Internet through the Internet accessing section to the program operating section, which in turn causes transmission of the video and audio data of only the selected wireless web camera to the user.

4. The system of claim 3, wherein the video and audio data of only the selected wireless web camera is transmitted to the user via a homepage.

5. The system of claim 1, wherein controlling the operation of the plurality of wireless web cameras under direction of a signal from across the Internet comprises the ability to adjust for each of the plurality of wireless web cameras at least one of the size of the data, channel, pan/tilt, zoom, focus, and position.

6. The system of claim 1, further comprising a power supply adjusting section adapted to turn power on and off.

7. A repeater installation for use in a monitoring and management system based on the Internet, comprising:
a radio data receiver adapted to receive video and audio data acquired by each of a plurality of wireless web cameras and adapted to output the received video and audio data;
a data modulator adapted to receive the outputted video and audio data from the radio data receiverfor modulating them into an analog signal and adapted to output the modulated analog signal;
a camera control section adapted to adjust channel, pan/tilt, zoom, focus and position of each of the plurality of wireless web cameras;
a data acquisition section adapted to receive the video signal and audio signal corresponding to the modulated analog signal from the data modulator and adapted to stabilize the received video and audio signals, and adapted to output them;
a program operating section adapted to store the video and audio data applied thereto from the data acquisition section and adjust the size of the data, channel, pan/tilt, zoom, focus and position of each of the plurality of wireless web cameras;
an Internet accessing section adapted to provide to a user interface the video and audio data stored in the program operating section; and
a power supply adjusting section adapted to turn the power supply on and off.

8. The repeater installation according to claim 7, wherein when a selection from the user interface selects any one of the plurality of wireless web cameras for receiving the video and audio signals, the selection signal is applied to the program operating section which, in turn, transmits only the video and audio signals of the selected wireless web camera to the user interface.

9. The repeater installation of claim 8, wherein the Internet accessing section is adapted to provide to a user interface the video and audio data stored in the program operating section via an Internet homepage associated with a user.

10. A method for monitoring and managing system based on the Internet, comprising steps of:
transmitting video and audio data from one or more cameras;
receiving video and audio data wireless from one or more cameras;
modulating the video and audio data into a modulated analog signal;
acquiring the modulated analog signal and stabilizing video and data signals thereof;
processing video and audio data acquired from the modulated signal; and
transmitting the processed video and audio data across the Internet for presentation through a user interface.

11. The method of claim 10, further comprising steps of:
selecting a camera from among the one or more cameras; and
transmitting a camera selection signal according to the selecting step.

12. The method of claim 11, wherein the selecting a camera from one or more cameras step causes video and audio data from only one camera to be transmitted across the Internet for presentation through the user interface.

13. The method of claim 10, further comprising steps of
transmitting a camera adjusting signal; and
adjusting one camera from among the one or more cameras based on the transmitted camera adjusting signal.

14. The method of claim 13, wherein the adjusting step adjusts size of data, channel, pan/tilt, zoom, focus, and position of at least one of the one or more cameras.

15. The method of claim 10, wherein the user interface includes a user homepage.

16. The method of claim 10, wherein the transmitting the processed video and audio data across the Internet for presentation through a user interface step includes presenting a plurality of video frames from a plurality of cameras.
